(19) United States
(12) Patent Application Publication
(10) Pub. No.: US 2013/0105082 A1
(43) Pub. Date: May 2, 2013

(54) SUBSTRATE PROCESSING DEVICE AND IMPEDANCE MATCHING METHOD

(71) Applicant: Semes Co., Ltd., Cheonan-si (KR)

(72) Inventors: Harutyun MELIKYAN, Cheonan-si (KR); Dukhyun SON, Cheonan-si (KR); Wonteak PARK, Seoul (KR); Hyo Seong SEONG, Masan-si (KR)

(73) Assignee: Semes Co., Ltd., Cheonan-si (KR)

(21) Appl. No.: 13/664,970

(22) Filed: Oct. 31, 2012

(30) Foreign Application Priority Data
Oct. 31, 2011 (KR) 10-2011-0112415
Dec. 22, 2011 (KR) 10-2011-0140018

(51) Int. Cl. C23F 1/08; H05H 1/24

(52) U.S. Cl. 156/345.28; 156/345.1; 315/111.21

(57) ABSTRACT

Provided are a substrate processing device and an impedance matching method. The substrate processing device includes: a high frequency power source for generating high frequency power; a process chamber for performing a plasma process by using the high frequency power; a matching circuit for compensating for a changed impedance of the process chamber; and a transformer disposed between the process chamber and the matching circuit in order to reduce the impedance of the process chamber.

### CROSS-REFERENCE TO RELATED APPLICATIONS

This U.S. non-provisional patent application claims priority under 35 U.S.C. §119 of Korean Patent Application Nos. 10-2011-00112415, filed on Oct. 31, 2011, and 10-2011-0140018, filed on Dec. 22, 2011, the entire contents of which are hereby incorporated by reference.

### BACKGROUND OF THE INVENTION

The present invention disclosed herein relates to a substrate processing device and an impedance matching method, and more particularly, to a substrate processing device for impedance matching during a plasma process and an impedance matching method.

Since high frequency power is used during a plasma process for processing a substrate with plasma, impedance matching is crucial. The impedance matching is to identically control the impedances at a transmission terminal and a reception terminal of power in order to effectively transmit the power. A plasma process requires the impedance matching between a power source that provides high frequency power and a chamber that receives the high frequency power in order to generate and maintain plasma.

Since an impedance of plasma is determined on the basis of different variables such as types, temperatures, and pressures of source gases, the impedance of a chamber continuously changes during a process. Accordingly, the impedance matching compensates for a changing impedance of a chamber through a matching circuit having a capacitor and an inductor during a plasma process.

However, since there are limitations in a response speed as an impedance is compensated by adjusting capacitance or inductive capacity, time delay occurs during impedance matching. Especially, when the impedance of a chamber is drastically changed as plasma is generated during an initial process, an electric arc and the density deviation of the plasma in the chamber occur due to reflected waves resulting from a not fast enough response to the impedance of the chamber.

### SUMMARY OF THE INVENTION

The present invention provides a substrate processing device that performs fast impedance matching and a substrate processing method.

The present invention also provides a substrate processing device that performs impedance matching on high frequency power in a wide frequency band and a substrate processing method.

Embodiments of the present invention provide substrate processing devices including: a high frequency power source for generating high frequency power; a process chamber for performing a plasma process by using the high frequency power; a matching circuit for compensating for a changed impedance of the process chamber; and a transformer disposed between the process chamber and the matching circuit in order to reduce the impedance of the process chamber.

In some embodiments, the transformer may be a Ruthroff transformer.

In other embodiments, the Ruthroff transformer may be a 1:4 unbalanced-to-unbalanced transformer.

In still other embodiments, the devices may further include: an impedance measuring unit for measuring an impedance of the process chamber; a reflected power measuring unit for measuring a reflected power; and a controller for controlling the matching circuit on the basis of measured values of the impedance measuring unit and the reflected power measuring unit.

In even other embodiments, the matching circuit may include a plurality of capacitors disposed in parallel to each other and a plurality of switches respectively connected to the plurality of capacitors; and the controller generates a control signal on the basis of the measured values; and the matching circuit opens/closes the plurality of switches in response to the control signal.

In yet other embodiments, the matching circuit may be an inverse-L-type circuit.

In further embodiments, the process chamber may include a housing that provides a space where the plasma process is performed and a plasma generator that provides plasma to the housing by using the high frequency power.

In still further embodiments, the plasma generator may be a capacitively coupled plasma (CCP) generator including a plurality of electrodes spaced apart from each other in the housing.

In even further embodiments, the high frequency power, the matching circuit, and the transformer may be in plurality; the high frequency power source may generate high frequency powers of different frequencies; the different frequencies may be applied to the plurality of electrodes; and the matching circuit and the transformer may be connected to each electrode to which the high frequency power is applied.

In other embodiments of the present invention, impedance matching methods in a substrate processing device that performs a plasma process by using high frequency power may include: reducing by a transformer a changed impedance of a process chamber during the plasma process, the transformer being disposed between a matching circuit and a process chamber; and compensating for the reduced impedance by the matching circuit in order to perform impedance matching.

In some embodiments, the transformer may be a 1:4 transformer; and the matching circuit may compensate for ¼ of a change in impedance of the process chamber in order to perform impedance matching.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view of the substrate processing device;

FIG. 2 is a diagram illustrating the substrate processing device of FIG. 1 according to an embodiment of the present invention;

FIG. 3 is a circuit diagram illustrating the matching circuit of FIG. 2 according to an embodiment of the present invention;

FIG. 4 is a circuit diagram illustrating the matching circuit of FIG. 2 according to another embodiment;

FIG. 5 is a circuit diagram illustrating the matching circuit of FIG. 2 according to further another embodiment;

FIG. 6 is a circuit diagram illustrating the transformer of FIG. 2 according to an embodiment;

FIG. 7 is a plan view illustrating the transformer of FIG. 6 according to an embodiment;

FIG. 8 is a view when a plurality of transformers of FIG. 6 are connected;

FIG. 9 is a graph illustrating a change in current by the transformer of FIG. 6;

FIG. 10 is a graph illustrating a change in voltage by the transformer of FIG. 6;

FIG. 11 is a graph illustrating a change in impedance by the transformer of FIG. 6;

FIGS. 12 to 14 are diagrams illustrating modifications of the substrate processing device of FIG. 1; and

FIG. 15 is a graph illustrating impedance matching in the substrate processing device of FIG. 14.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, a substrate processing device 100 according to the present invention will be described.

The substrate processing device 100 performs a process. The plasma process may include a plasma deposition process, a plasma etching process, a plasma ashing process, and a plasma cleaning process. During such as plasma process, high frequency power is applied to source gas in order to generate plasma. Of course, the substrate processing device 100 may perform various plasma processes besides the above example.

Moreover, a substrate herein includes a flat panel display (FPD) and also all substrates used for manufacturing a product having a circuit pattern on a thin film.

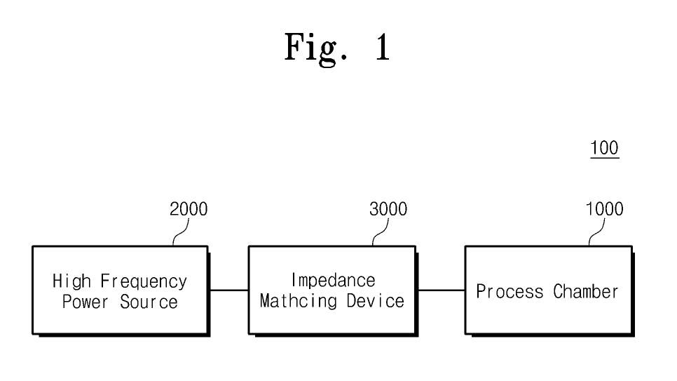

FIG. 1 is a view of the substrate processing device 100.

Referring to FIG. 1, the substrate processing device 100 includes a process chamber 1000, a high frequency power source 2000, an impedance matching device 3000, and a transmission line 110. The process chamber 1000 performs a plasma process by using high frequency power. The high frequency power source 2000 generates high frequency power and the transmission line 110 connects the high frequency power source 2000 with the process chamber 1000, and transmits high frequency power to the process chamber 1000. The impedance matching device 3000 matches the impedance between the high frequency power source 2000 and the process chamber 1000.

Hereinafter, the substrate processing device 100 according to an embodiment of the present invention will be described.

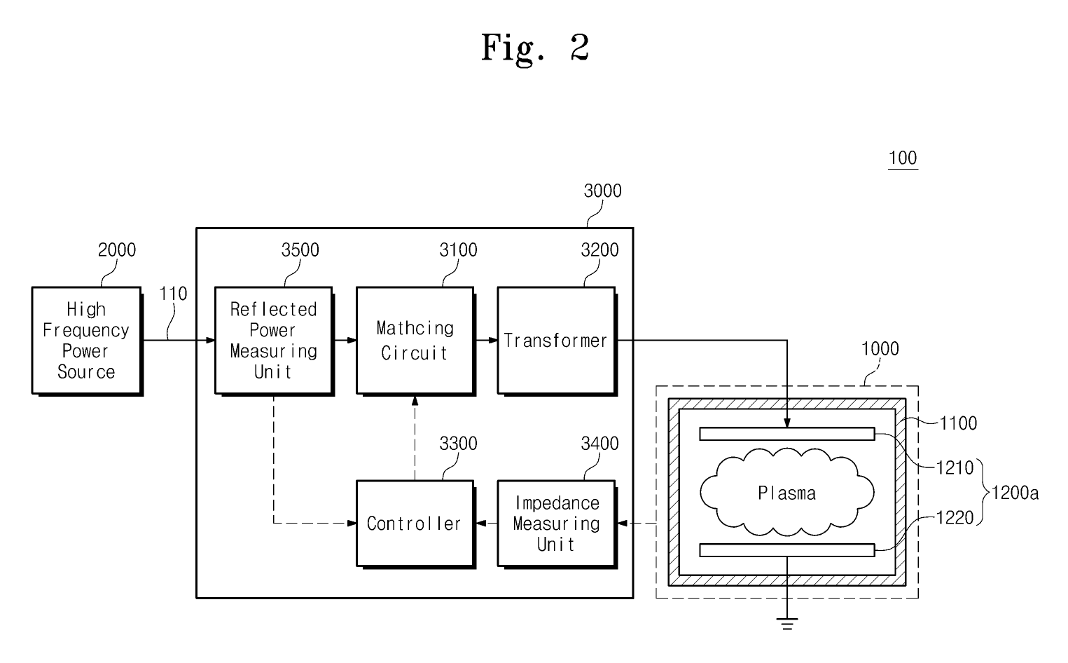

FIG. 2 is a diagram illustrating the substrate processing device 100 of FIG. 1 according to an embodiment of the present invention.

The process chamber 1000 includes a housing 1100 and a plasma generator 1200.

The housing 1100 provides a space where a plasma process is performed.

The plasma generator 1200 provides plasma to the housing 1100. The plasma generator 1200 applies high frequency power to a source gas in order to generate plasma.

A capacitively coupled plasma generator (CCPG) 1200a may be used as the plasma generator 1200.

The CCPG 1200a may include a plurality of electrodes in the housing 1100.

For example, the CCPG 1200a may include a first electrode 1210 and a second electrode 1220. The first electrode 1210 is disposed at the inside top of the housing 1100, and the second electrode 1220 is disposed at the inside bottom of the housing 1100. The first electrode 1210 and the second electrode 1220 are vertically disposed parallel to each other. High frequency power is applied to one of the first and second electrodes 1210 and 1220 through the transmission line 110, and the other one is grounded. Once high frequency power is applied, a capacitive electric field is formed between the first electrode 1210 and the second electrode 1220. A source gas between the first and second electrodes 1210 and 1220 is ionized by receiving electrical energy from the capacitive electric field, and becomes a plasma state. Moreover, such a source gas may flow from an external gas supply source (not shown) to the housing 1100.

The high frequency power source 2000 generates high frequency power. Here, the high frequency power source 2000 may generate high frequency power in a pulse mode. The high frequency power source 2000 may generate a high frequency power of a specific frequency. For example, the high frequency power source 2000 may generate power of 2 Mhz, 13.56 Mhz, or 100 Mhz frequency. Of course, the high frequency power source 2000 may generate a high frequency power of another frequency besides the above frequency.

The transmission line 110 transmits high frequency power from the high frequency power source 2000 to the process chamber 1000.

As high frequency power is transmitted through the transmission line 110 in such a manner, if the impedances at the transmission terminal and the reception terminal of the power therein are mismatched, reflected waves occur, thereby causing reflected power. In the case of high frequency power, delay power occurs in a non-consumable circuit such as a capacitor or a capacitor during the transmission process, so that reflective waves occur due to phase differences. Once such reflective waves occur, power transmission efficiency is deteriorated. Moreover, the power from the high frequency power source 2000 to the process chamber 1000 becomes irregular, so that it becomes difficult to generate plasma or maintain uniform density. Additionally, when reflective waves are accumulated in the process chamber 1000, arc discharge occurs, which may directly damage the substrate S.

The impedance matching device 300 may perform impedance matching. Once impedance is matched, reflected waves do not occur and power is efficiently transmitted.

The impedance matching device 3000 may include a matching circuit 3100, a transformer 3200, a controller 3300, an impedance measuring unit 3400, and a reflective power measuring unit 3500.

The matching circuit 3100 matches an impedance at the process chamber 1000 with that at the high frequency power source 2000. The matching circuit 3100 includes a circuit device such as a capacitor or an inductor. All or some of circuit devices of the matching circuit 3100 may be variable circuit devices.

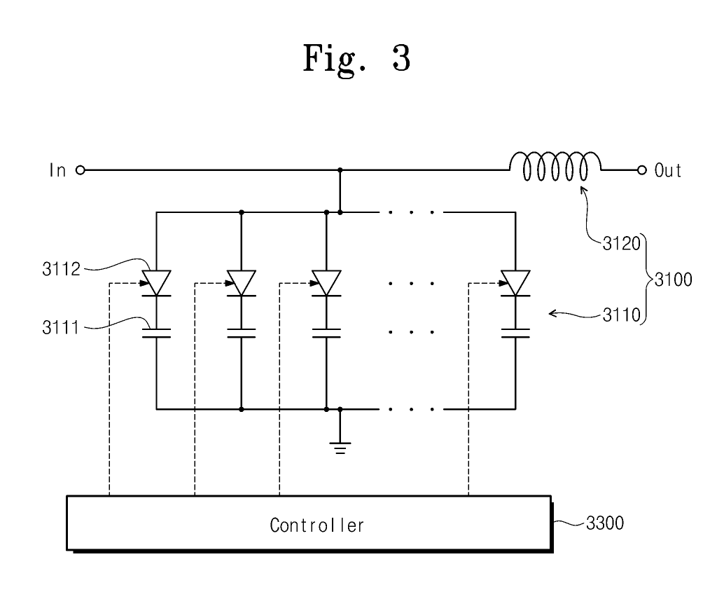

FIG. 3 is a circuit diagram illustrating the matching circuit 3100 of FIG. 2.

According to an embodiment, the matching circuit 3100 may include a variable capacitor 3110 and an inductor 3120. Referring to FIG. 3, the variable capacitor 3110 may be connected in parallel and the inductor 3120 may be connected in series on the transmission line 110. The matching circuit 3100 adjusts the capacitance of the variable capacitor 3110 in order for impedance matching.

The variable capacitor 3110 may include a plurality of capacitors 3111 and a plurality of switches 3112. The plurality of capacitors 3111 may be connected in parallel to each other. The plurality of switches 3112 are respectively connected to the plurality of capacitors 3111, and may be closed or opened in response to a control of the controller 3300 that will be described later.

The switch 3112 may adjust a short circuit of a capacitor and the high frequency transmission line 110 in response to a control signal from the controller 3300. A plurality of capacitors are connected to the switch 3112 that adjusts their short circuits. For example, the controller 3300 transmits a control signal that controls the short circuit of the switch 3112, and the switch 3112 adjusts the short circuit of each capacitor according thereto.

A digital switch may be used as the switch 3112. For example, the switch 3112 may include an RF relay, a PIN diode, and a metal-oxide semiconductor field effect transistor (MOSFET). Such a digital switch opens/closes a corresponding capacitor 3110 in response to an ON/OFF signal, so that it may compensate for impedance at a faster response speed than a mechanically-driven switch. Accordingly, a response speed of impedance matching is improved, delay time is reduced, and reflected waves are removed.

The capacitance of such a variable capacitor 3110 may be determined according to the state combination of the switch 3112. That is, the capacitance of the variable capacitor 3110 may be determined according to the sum of capacitances of the capacitors 3111 having the switches 3112 closed, among the capacitors 3111 connected in parallel.

Here, the plurality of capacitors 3111 may have the same capacitance. Additionally, the plurality of capacitors 3111 may be provided with a 1:2:3: . . .n:ratio of their capacitances. Additionally, the plurality of capacitors 3111 may be provided with a 1:21:22: . . . 2n:ratio of their capacitances.

Since the total capacitance of the variable capacitor 3110 is the sum of the connected capacitors 3111, when the capacitor 3111 has a capacitance according to the above value, the capacitance of the variable capacitor 3110 is easily controlled and is applicable to a wide range.

However, although the matching circuit 3100 including one variable capacitor 3110 and the inductor 3120 was described above, types, numbers, and connection relationships of circuit devices constituting the matching circuit 3100 may be different from the above.

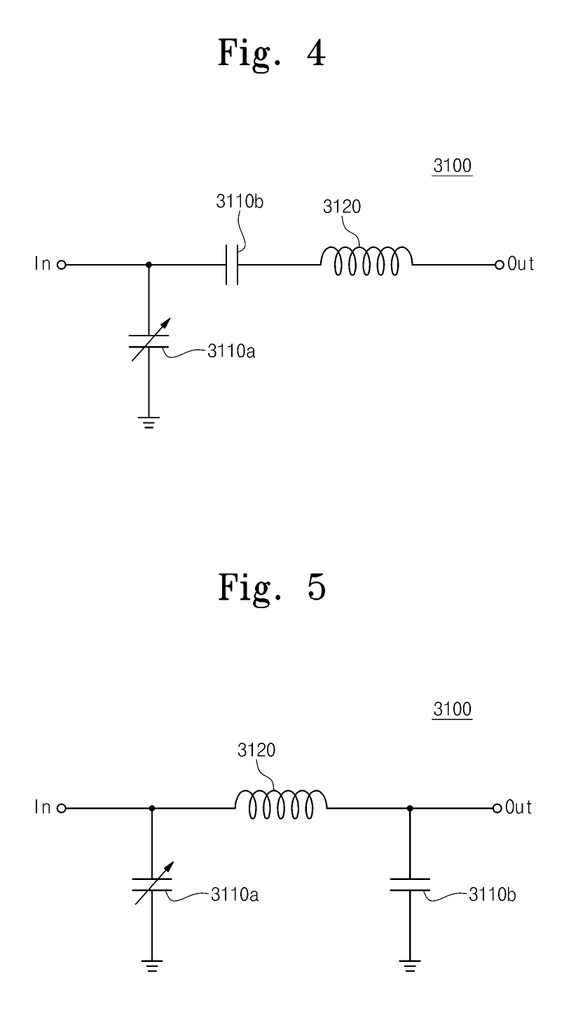

FIG. 4 is a circuit diagram illustrating the matching circuit 3100 of FIG. 2 according to another embodiment. FIG. 5 is a circuit diagram illustrating the matching circuit 3100 of FIG. 2 according to further another embodiment.

Referring to FIG. 4, the matching circuit 3100 may be implemented with an L type circuit including a variable capacitor 3110a connected in parallel to the transmission line 110, and a capacitor 3110b and an inductor 3120 connected in series to the transmission line 110. Additionally, referring to FIG. 5, the matching circuit 3100 may be implemented with a it type including an inductor 3120 connected in series to the transmission line 110, and a variable capacitor 3110a and a capacitor 3110b connected in parallel to the transmission line 110. Of course, the matching circuit 3100 may be implemented with an inverse L type circuit, various kinds of typical circuits, and circuits properly modified if necessary.

The transformer 3200 is installed on the transmission line 110 in order to transform impedances at an input side and an output side.

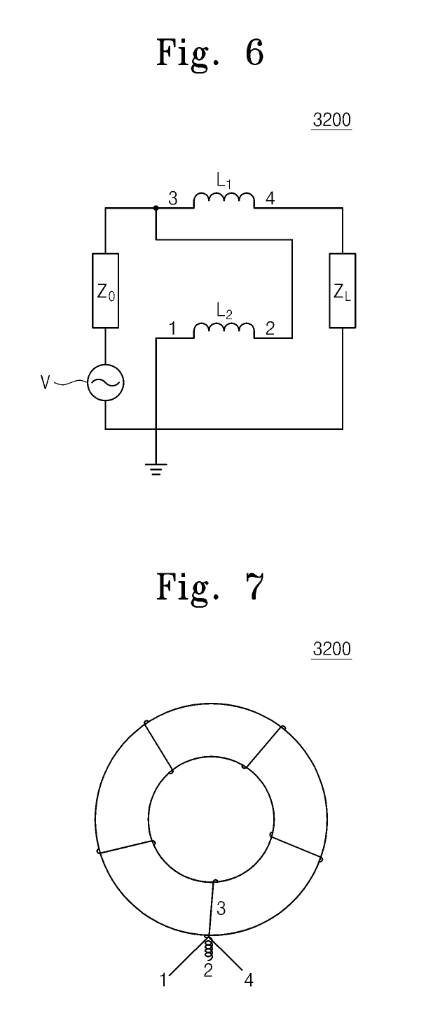

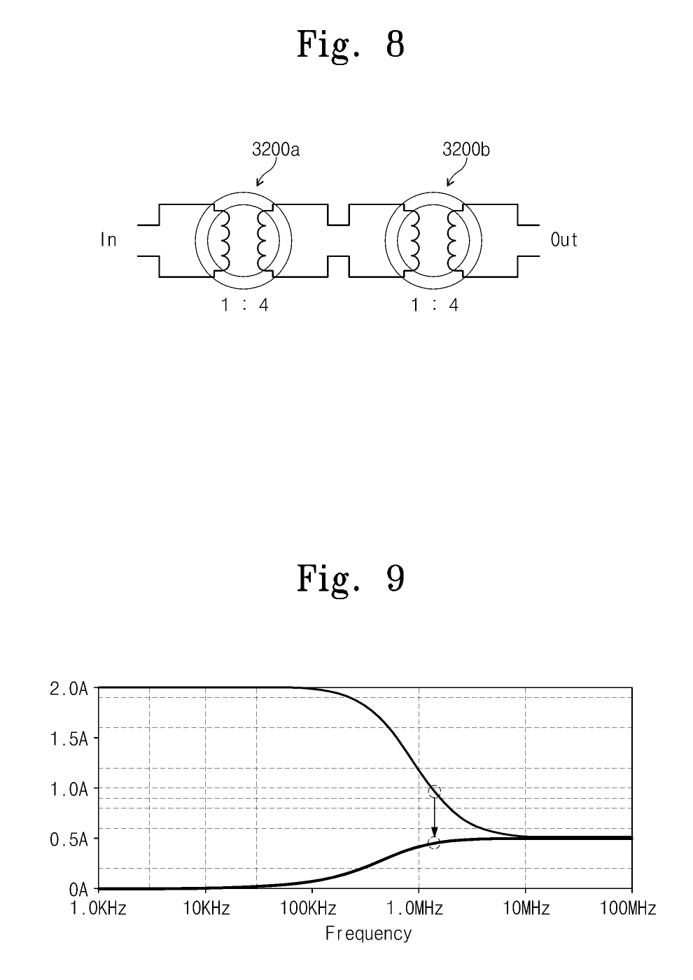

FIG. 6 is a circuit diagram illustrating the transformer 3200 of FIG. 2 according to an embodiment. FIG. 7 is a plan view illustrating the transformer 3200 of FIG. 6 according to an embodiment.

Referring to FIG. 6, a Ruthroff transformer may be used as the transformer 3200. The Ruthroff transformer performs impedance transformation with respect to a wide bandwidth, and has excellent transmission efficiency. FIGS. 6 and 7 illustrate a 1:4 unbalanced-to-unbalanced Ruthroff transformer. As shown in FIG. 7, the 1:4 Ruthroff transformer may be manufactured by winding a twisted wire on a ring-shaped core through a bootstrap principle. At this point, if a first coil L1 and a second coil L2 has the same value, a transformation ratio of an impedance at an output side and an impedance at an input side becomes 1:4.

If the number of twisted wires wound on a core is increased in such a Ruthroff transformer, a transformation ratio of impedance is changed. In the case of three twisted wires, a 1:2.25 unbalanced-to-unbalanced transformer operates. In the case of four twisted wires, a transformation ratio of 1:1.78 is provided.

Moreover, when a Ruthroff transformer is connected in series, a larger transformation ratio may be provided.

FIG. 8 is a view when a plurality of transformers 3200 of FIG. 6 are connected.

Referring to FIG. 8, when two 1:4 unbalanced-to-unbalanced transformers are connected in series, a primary output side with respect to an input side has a 1:4 transformation ratio, and a transformation ratio of the final output side to the primary output side becomes 1:4 again. Therefore, the impedance transformation ratio of the final output side to the input side becomes 1:16.

In the substrate processing device 100, the transmission line 110 is connected from the high frequency power source 2000 to the process chamber 1000, and the matching circuit 3100 and the transformer 2300 may be connected therebetween. That is, the transmission line 110 may sequentially connect the high frequency power source 2000, the matching circuit 3100, the transformer 3200, and the process chamber 1000.

Accordingly, the high frequency power source 2000 and the matching circuit 3200 are disposed at the input side of the transformer 3200, and the process chamber 1000 is disposed at the output side, on the basis of the transformer 3200. Accordingly, the transformer 3200 may reduce the impedance at the process chamber 1000.

In general, the high frequency power source 2000 has a fixed impedance, for example, approximately 50 Ohms, but the process chamber 1000 has an impedance of at least several Ohms to at most 300 Ohms during a plasma process. When the impedance of the process chamber 1000 is delivered to the input side through the transformer 3200, approximately 70 Ohms are reduced in the case of a 1:4 unbalanced-to-unbalanced transformer. Therefore, even when the impedance of the process chamber 1000 is changed significantly by several hundreds Ohms in the matching circuit 3100 connected to the input side, an impedance between the process chamber 1000 and the high frequency power source 2000 may be matched by adjusting an impedance as much as it is reduced according to a transformation ratio.

Especially, when power is supplied to the process chamber 1000 in a pulse mode and plasma is generated by a high-speed pulse at the beginning of a plasma process, an impedance is drastically changed. Then, the matching circuit 3100 compensates for a changed impedance reduced by the transformer 3200 in order to match the impedance. Therefore, an impedance matching speed may be improved.

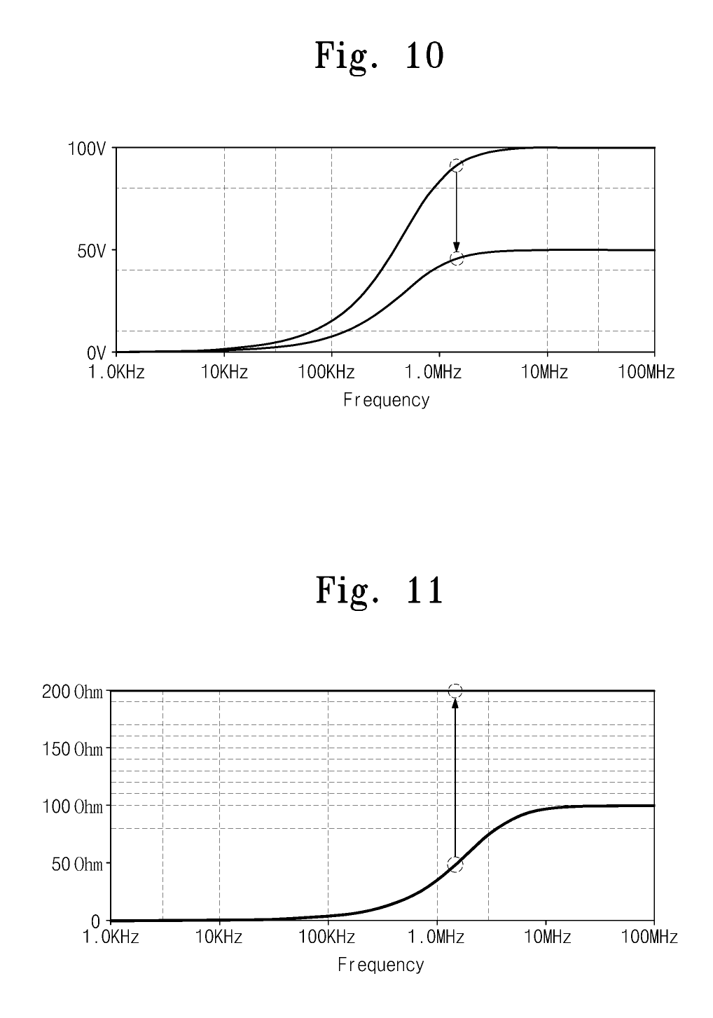

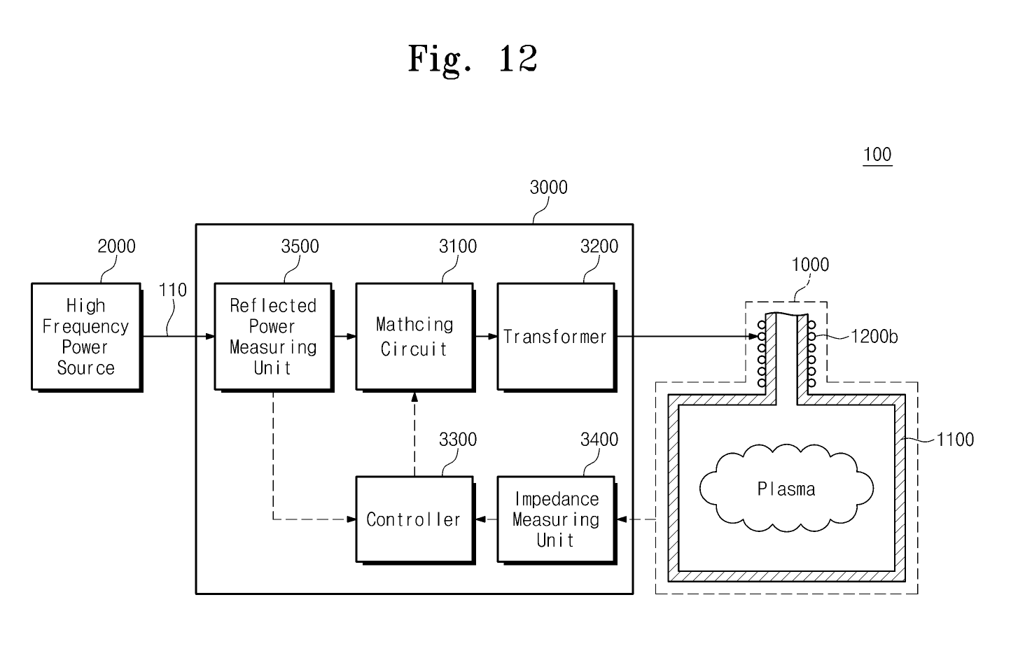

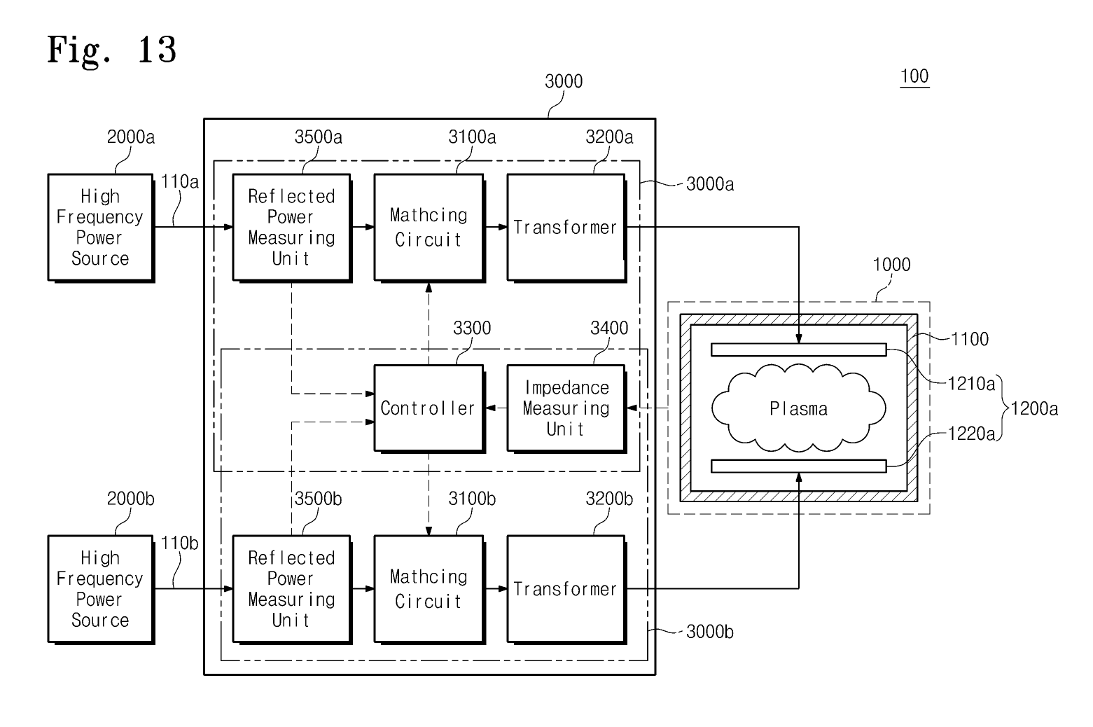

FIG. 9 is a graph illustrating a change in current by the transformer 3200 of FIG. 6. FIG. 10 is a graph illustrating a change in voltage by the transformer 3200 of FIG. 6. FIG. 11 is a graph illustrating a change in impedance by the transformer 3200 of FIG. 6.

Referring to FIGS. 9 and 10, in the case of a 1:4 unbalanced-to-unbalanced Ruthroff transformer and a high frequency power of 2 Mhz frequency, compared to the side of the process chamber 1000, current and voltage values are increased by two times and an impedance is reduced to ¼ at the side of the high frequency power source 2000.

However, the transformer 3200 is not limited to the above example, and the Ruthrof transformer may be replaced with a transformer that performs the same or similar functions thereof.

The controller 3300 generates a control signal for impedance compensation on the basis of measurement values of the impedance measuring unit 3400 and the reflected power measuring unit 3500, and transmits the control signal to the matching circuit 3100 in order to control it. Here, the impedance measuring unit 3400 measures an impedance of the process chamber 1000, and transmits the measured value to the controller 3300. Additionally, the reflected power measuring unit 3500 measures a reflected power due to reflected waves, and transmits the measured value to the controller 3300.

For example, a control signal is to turn on/off the plurality of switches 3120 in the matching circuit 3100. As the switch 3120 is closed or opened in response to a control signal in the matching circuit 3100, its capacitance may be adjusted.

Such a controller 3300 may be implemented with a computer or a device similar thereto by using hardware, software, or a combination thereof.

In terms of hardware, the controller 3300 may be implemented with application specific integrated circuits (ASICs), digital signal processors (DSPs), digital signal processing devices (DSPDs), programmable logic devices (PLDs), field programmable gate arrays (FPGAs), processors, micro-controllers, microprocessors, or electrical devices that perform control functions similar thereto.

Additionally, in terms of software, the controller 3300 may be implemented with software codes or software applications, which are written in at least one program language. Moreover, software is installed as being transmitted from an external device such as a software server into the above-mentioned hardware configuration.

The substrate processing device 100 was described on the basis of the process chamber 1000 including the CCPG 1200a to which a high frequency power of a single frequency is applied, but the substrate processing device 100 may be different from the above.

FIGS. 12 to 14 are diagrams illustrating modifications of the substrate processing device 100 of FIG. 1.

Referring to FIG. 12, instead of the CCPG 1200a, an inductively coupled plasma generator (ICPG) 1200b may be used in the process chamber 1000 in the substrate processing device 100. The ICPG 1200b is installed around a portion where a source gas flows into the process chamber 1000 in order to form an induced electric field. Accordingly, the source gas flowing into the process chamber 1000 is ionized by an induced electric field and becomes a plasma state.

Additionally, the process chamber 1000 in the substrate processing device 100 may perform a plasma process by simultaneously using high frequency powers of different frequencies. In the case of a plasma etching process, when a plasma process is performed using a plurality of different high frequency powers, more excellent effect may be obtained compared to the case that a high frequency power of a single frequency is used.

Referring to FIG. 13, both electrodes 1210a and 1210b of the CCPG 1200a in the substrate processing device 100 may be respectively connected to the two high frequency power sources 2000a and 2000b that generate high frequency powers of different frequencies. Accordingly, different high frequency powers are applied to the first electrode 1210a and the second electrode 1210b, so that a plasma process is performed by simultaneously using high frequency powers of two different frequencies.

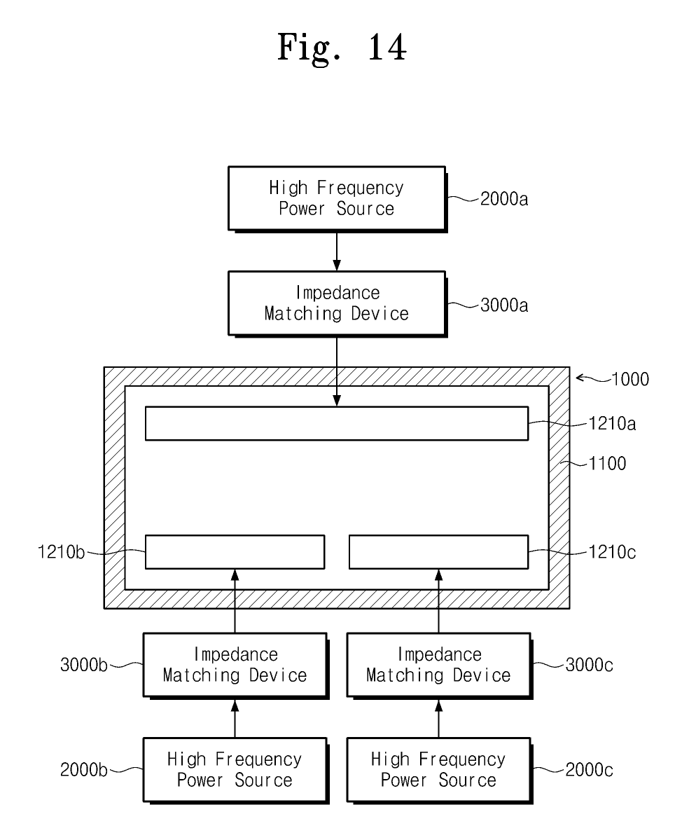

Referring to FIG. 14, three different frequencies may be used in the substrate processing device 100. For example, the first electrode 1210a is disposed on the top of the housing 1100, and the second electrode 1210b and the third electrode 1210c are disposed below and spaced from the first electrode 1210a. At this point, high frequency power sources 2000a, 2000b, and 2000c for generating different first high frequency power, second high frequency power, and third high frequency power are respectively connected to the electrodes 1210a, 1210b, and 1210c. Accordingly, a plasma process is performed by in the process chamber 1000 by simultaneously using the three high frequency powers. For example, the first high frequency power, the second high frequency power, and the third high frequency power may be 2 Mhz, 13.6 Mhz, and 100 Mhz, respectively. Moreover, in some cases, the second electrode 1210b and the third electrode 1210c may be integrally provided.

When a frequency of a broad bandwidth is used simultaneously like the above, it is difficult to predict a change in impedance and match an impedance due to a different bandwidth. However, the Ruthroff transformer transforms an impedance with respect to a broad bandwidth, and thus is effectively used.

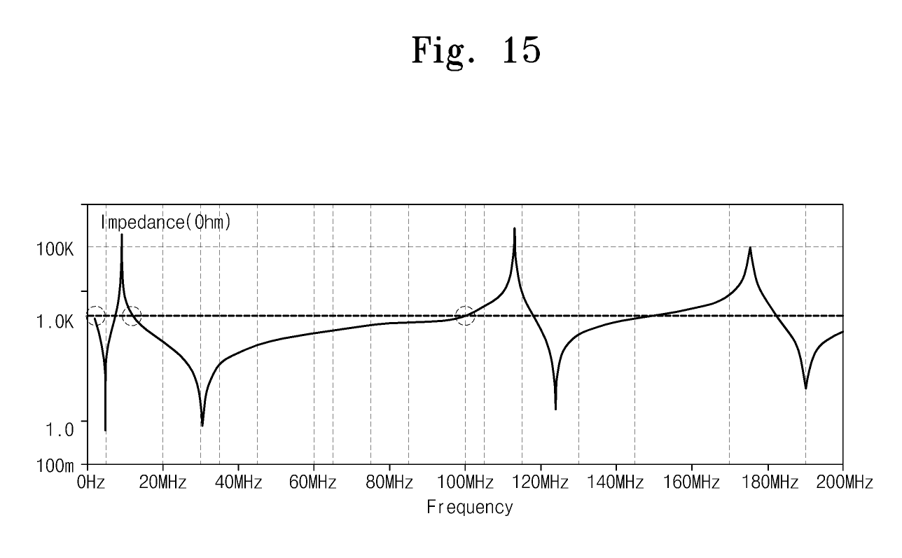

FIG. 15 is a graph illustrating impedance matching in the substrate processing device 100 of FIG. 14.

Referring to FIG. 15, when a 1:4 unbalanced-to-unbalanced Ruthroff transformer is used, an impedance is matched to 50 Ohm of a fixed impedance at the side of the high frequency power source 2000, with respect to three bandwidths of 2 Mhz, 13.6 Mhz, and 100 Mhz.

Hereinafter, an impedance matching method using the substrate processing device 100 according to the present invention will be described. However, the impedance matching method may be performed by using other devices, which are identical or similar to the above-mentioned substrate processing device 100. Additionally, such an impedance matching method may be stored in a computer readable recording medium through the forms of codes or programs for executing the method.

In relation to the impedance matching method, a source gas flows from a gas supply source (not shown) into the process chamber 1000 first. Once the source gas flows, the high frequency power source 2000 generates high frequency power, and transmits the generated high frequency power to the plasma generator 1200 through the transmission line 110. The plasma generator 1200 generates plasma by ionizing a source gas with the high frequency power. Once the plasma is generated, the process chamber 1000 processes the substrate by using the plasma. Therefore, while plasma is generated and a substrate is processed, a plasma impedance or an impedance of the process chamber 1000 is changed by various process conditions such as foreign materials from a substrate, the density of plasma, the type of a source gas, and the internal temperature and internal pressure of the process chamber 1000. Especially, an impedance may be drastically changed at the beginning of a plasma process that provides high frequency power in a pulse mode.

The impedance measuring unit 3400 measures an impedance of the process chamber 1000 and applies the measured value to the controller 3300. Additionally, impedance matching may be broken as impedance is changed, and due to this, reflected waves may occur. At this point, the reflected power measuring unit 3500 measures a reflected power at the side of the high frequency power source 2000, and applies the measured value to the controller 3300.

The controller 3300 obtains the measured value from the impedance measuring unit 3400 and the reflected power measuring unit 3500 in order to generate a control signal, and transmits the generated control signal to the matching circuit 3100.

In the matching circuit 3100, the plurality of switches 3112 are opened or closed in response to the control signal. A capacitance of the variable capacitor 3110 is adjusted to the sum of capacitances of the capacitors 3111 connected to the closed switches 3112 in the plurality of switches 3112. As a result, impedance matching is accomplished at the high frequency power source 2000 and the process chamber 1000. However, the circuit configuration of the matching circuit 3100 is not limited to the variable capacitor 3110. Even in some different configurations, impedance may be compensated in response to a control signal in a similar manner.

The controller 3300 transmits a digital signal during such an impedance matching process, the digital switch 3112 implemented with a diode or a transistor is turned on/off in response to a control signal, so that it compensates for impedance faster compared to a mechanical switch.

Here, the matching circuit 3100 may perform impedance matching on an actual changed impedance in the process chamber 1000 by compensating for a reduced change through the transformer 3200. The transformer 3200 is disposed between the matching circuit 3100 and the process chamber 1000, so that it may reduce an impedance of the process chamber 1000 at the matching circuit 3100.

When a 1:4 unbalanced-to-unbalanced Ruthroff transformer is used, the impedance of the process chamber 1000 is reduced to ¼. Accordingly, the matching circuit 3100 compensates for an impedance having the ¼ size of an impedance change in the process chamber 1000 in order to perform impedance matching.

Especially, since an impedance of the process chamber 1000 is drastically changed while power is supplied in an initial pulse mode of a plasma process, the matching circuit 3100 uses a digital switch, a minimum delay time may occur. However, since its impedance change is reduced and a response speed of the matching circuit 3200 is improved, so that reflected waves may be minimized.

According to the present invention, even when an impedance of a process chamber is changed drastically, a matching circuit compensates for an impedance change that is reduced through a transformer. Therefore, fast matching is possible.

According to the present invention, since impedance matching is fast, delay time is reduced and reflected waves are removed to prevent arc discharge during a process chamber. Therefore, process efficiency is increased.

According to the present invention, since a Ruthroff transformer is used, impedance matching is accomplished on high frequency power having various frequencies of a wide bandwidth.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A substrate processing device comprising:
a high frequency power source for generating high frequency power;
a process chamber for performing a plasma process by using the high frequency power;
a matching circuit for compensating for a changed impedance of the process chamber; and
a transformer disposed between the process chamber and the matching circuit in order to reduce the impedance of the process chamber.

2. The device of claim 1, wherein the transformer is a Ruthroff transformer.

3. The device of claim 2, wherein the Ruthroff transformer is a 1:4 unbalanced-to-unbalanced transformer.

4. The device of claim 1, further comprising:
an impedance measuring unit for measuring an impedance of the process chamber;
a reflected power measuring unit for measuring a reflected power; and
a controller for controlling the matching circuit on the basis of measured values of the impedance measuring unit and the reflected power measuring unit.

5. The device of claim 4, wherein
the matching circuit comprises a plurality of capacitors disposed in parallel to each other and a plurality of switches respectively connected to the plurality of capacitors;
the controller generates a control signal on the basis of the measured values; and
the matching circuit opens/closes the plurality of switches in response to the control signal.

6. The device of claim 1, wherein the matching circuit is an inverse-L-type circuit.

7. The device of claim 1, wherein the process chamber comprises a housing that provides a space where the plasma process is performed and a plasma generator that provides plasma to the housing by using the high frequency power.

8. The device of claim 7, wherein the plasma generator is a capacitively coupled plasma (CCP) generator including a plurality of electrodes spaced apart from each other in the housing.

9. The device of claim 8, wherein
the high frequency power, the matching circuit, and the transformer are in plurality;
the high frequency power source generates high frequency powers of different frequencies;
the different frequencies are applied to the plurality of electrodes; and
the matching circuit and the transformer are connected to each electrode to which the high frequency power is applied.

10. An impedance matching method in a substrate processing device that performs a plasma process by using high frequency power, the method comprising:
reducing by a transformer a changed impedance of a process chamber during the plasma process, the transformer being disposed between a matching circuit and a process chamber; and
compensating for the reduced impedance by the matching circuit in order to perform impedance matching.

11. The method of claim 10, wherein the transformer is a 1:4 transformer; and
the matching circuit compensates for ¼ of a change in impedance of the process chamber in order to perform impedance matching.
